(19) United States
(12) Patent Application Publication
(10) Pub. No.: US 2016/0351063 A1
(43) Pub. Date: Dec. 1, 2016

(54) Positive Random Message Generating Device

(71) Applicant: Marvin Robinson, North Hollywood, CA (US)

(72) Inventor: Marvin Robinson, North Hollywood, CA (US)

(21) Appl. No.: 15/169,652

(22) Filed: May 31, 2016

Related U.S. Application Data
(60) Provisional application No. 62/168,039, filed on May 29, 2015.

(51) Int. Cl. G09B 5/04; G09B 19/00

(52) U.S. Cl. CPC G09B 5/04; G09B 19/00

(57) ABSTRACT

A message generating device for providing a user with energy, optimism, courage, and positive motivational support is provided. The message generating device comprises a base having a top side and a bottom side with a speaker mounted in the base and a button depressibly mounted to the top side of the base. An internal electronic memory storage device is mounted within the base for preserving information for retrieval. Upon depressing the button, a positive verbal message is played through the speaker providing a user with energy, optimism, courage and positive motivational support.

### CLAIM OF PRIORITY

This patent application claims priority under 35 USC 119 (e) (1) from U.S. Provisional Patent Application Ser. No. 62/168,039 filed May 29, 2015, of common inventorship herewith entitled, “Ego Boost,” which is incorporated herein by reference as though the same were set forth in its entirety.

### FIELD OF THE INVENTION

The present invention pertains to the field of psychological motivation, and more specifically to the field of positive reinforcement communications.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Every living individual faces difficulties and challenges on a daily basis and every single person on earth needs a word of support, encouragement and optimism from time to time. In a perfect world, every individual receives support and encouragement from their parents, spouses, bosses, coworkers, children, and colleagues. In the real world, individuals are toiling away facing their challenges and doing their best every day without positive and vital verbal support from others that would lighten their load and make their lives better.

The prior art has put forth several designs for positive reinforcement communications. Among these are:

US Patent 2012/0308973 to Meghan L. Marsac and Anne Marie Vinsel describes a kit for use in promoting a patient's positive adjustment. The kit includes a plurality of modules with each module containing instructions for coping with a specific stress symptom and a transitional object having a module receiver. The module receiver receives one of the modules and deliver the instructions on the module to the patient. A method of promoting positive adjustment includes the steps of providing a patient with a transitional object and a plurality of modules. Each module unit contains instructions for coping with a specific stress symptom, identifying a stress symptom, selecting a module having instructions for coping with the stress symptom and delivering the instructions on the selected module to the patient with the transitional object.

US Patent 2011/0250819 to Daniel Francis Tashman describes an activity data collection and transmittal device that is used in sports or recreational activities to incorporate an electronic component that interacts with the user and other users. The activity device contains an electronic housing and has no impediment upon the activity being performed. The electronic housing has components that collect activity data in the form of a picture, a sound bite, activity statistics, personal information about the user or participants, or previous scoring information or rules of the activity. The activity device processes the collected activity data and sends the processed activity data to a receiving device. Viewers of the activity data can interactively communicate back to the original activity device.

U.S. Pat. No. 8,064,295 to Robin B. Palmer describes a motivational alarm having a timekeeping device and an alarm programming means to produce an alarm signal at a programmed alarm time. The alarm programming means is operatively connected to the timekeeping device. A digital storage device is operatively connected to the timekeeping device. A plurality of messages are prerecorded on the digital storage device. A playback means converts at least a portion of the plurality of recorded messages into an audible signal upon receipt of the alarm signal. The recorded messages preferably have a topic related to exercise, spirituality, religion, religious text, esteem building, health and wellness, encouragement for individuals, invigoration for long term caretakers, wealth building, and tragedy or loss recovery.

None of these prior art references describe the present invention.

### SUMMARY OF THE INVENTION

It is an object of the present invention to provide a pushbutton, battery powered electronic device containing a randomly programmed series of short recorded verbal messages that effectively and immediately function to provide a user with energy, optimism, courage, and positive motivational support.

The present invention is a message generating device for providing a user with energy, optimism, courage, and positive motivational support. The message generating device comprises a base having a top side and a bottom side with a speaker mounted in the base and a button depressibly mounted to the top side of the base. An internal electronic memory storage device is mounted within the base for preserving information for retrieval. Upon depressing the button, a positive verbal message is played through the speaker providing a user with energy, optimism, courage and positive motivational support.

In addition, the present invention is a method for providing a user with energy, optimism, courage, and positive motivational support. The method comprises providing a base having a substantially dome-shaped top side and a substantially flat bottom side, mounting a speaker in the base, mounting a depressable button to the top side of the base, mounting an internal electronic memory storage device within the base for preserving information for retrieval, depressing the button, playing a positive verbal message through the speaker, and providing a user with energy, optimism, courage and positive motivational,support.

The present invention further includes a message generating device for providing a user with energy, optimism, courage, and positive motivational support. The message generating device comprises a base having a top side and a bottom side with a speaker mounted in the base and a button depressibly mounted to the top side of the base. An internal electronic memory storage device is mounted within the base for storing at least one positive verbal message. Upon depressing the button, the at least one positive verbal message is played through the speaker providing a user with energy, optimism, courage and positive motivational support. The positive verbal message complements the user reminding them of their positive character and abilities, and set their day back on a positive, optimistic course.

### BRIEF DESCRIPTION OF THE DRAWINGS

FIG. 1 is a perspective view illustrating a positive random message generating device, constructed in accordance with the present invention, having various recorded messages emitted by means of an internal storage drive and audio speaker.

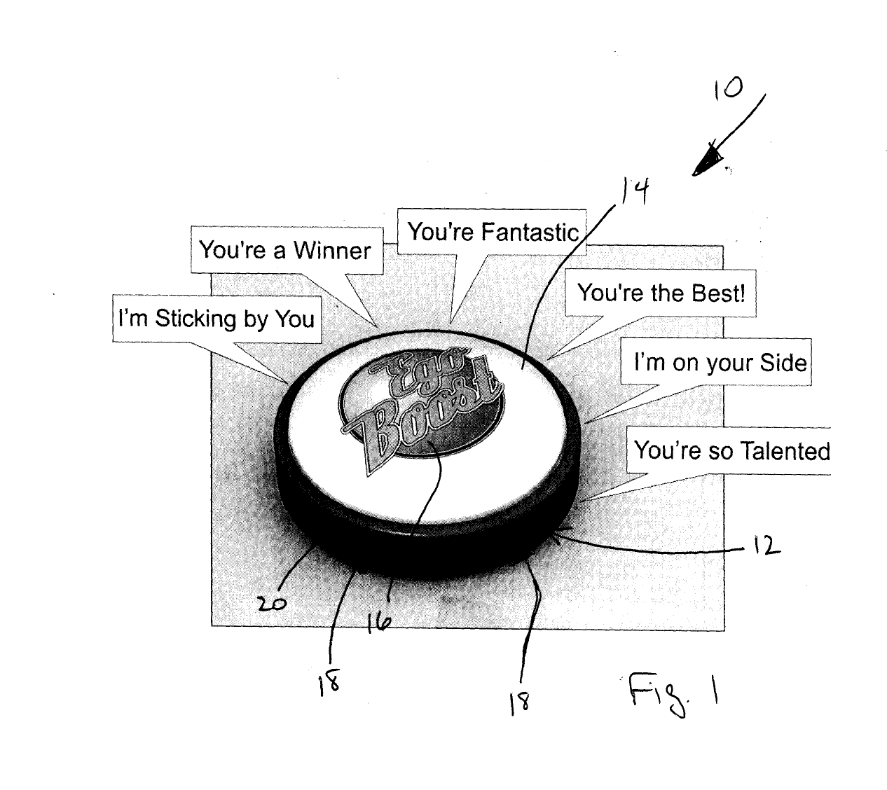

### DETAILED DESCRIPTION OF THE INVENTION

The present invention, hereinafter referred to as the Positive Random Message Generating Device, indicated generally at 10, is a pushbutton, battery powered electronic device containing a randomly programmed series of short recorded verbal messages that provide a user with energy, optimism, courage, and positive emotional support. The Positive Random Message Generating Device 10 provides individuals of all generations and backgrounds with an instant word of support, encouragement, and uplift.

The Positive Random Message Generating Device 10 of the present invention is a pushbutton device sized and shaped for positioning on a desk or the like. The Positive Random Message Generating Device 10 includes a base 12 or housing having an oversized button 14 preferably positioned on a top surface of the base 12. Upon pushing the button, the Positive Random Message Generating Device 10 responds with a variety of recorded messages constructed to complement the listener, remind them of their positive character and abilities, and set their day back on a positive, optimistic course.

The button 14 of the Positive Random Message Generating Device 10 of the present invention is physically configured as an oversized, dome shaped, circular button 14 that is graphically embellished with an appealing Positive Random Message Generating Device logo 16. A bottom surface of the base 12 of the Positive Random Message Generating Device 10 is preferably equipped with approximately four to six nonslip rubber pads 18 to stabilize the base 12 on a desktop, counter, or tabletop. In addition, the base 12 of the present invention contains a snap locking battery compartment for holding approximately three AAA batteries.

When the button 14 of the Positive Random Message Generating Device 10 of the present invention is depressed, a series of prerecorded verbal messages are accessed randomly, such that a different message is accessed with each press and the same message is never replayed sequentially. The digitally recorded messages are spoken in a masculine or feminine voice and are broadcast by means of a speaker 20 concealed within the base 12 of the Positive Random Message Generating Device 10. Examples of the uplifting and encouraging messages include You're the Best, You're Number One, I Like You, You're Marvelous, I'm Your Friend, I'm on Your Side, You're Fantastic, I'm Standing with You, You're a Star, You're a Winner, You're the Greatest, I'm your Buddy, I'm your Pal, I'm Sticking by You, You're So Talented, You're a Pro, You're Spectacular, You Can Do It, and I Stand by You. A user can supplement these generic messages by adding customized messages specifically focusing on a user's desired personal attributes and goals.

Using the Positive Random Message Generating Device 10 of the present invention is simple and straightforward. When in need of a little encouragement, the user takes a quick moment and presses the button 14. A reassuring voice from Positive Random Message

Generating Device 10 emits immediate words of encouragement and positive motivation. This positive reinforcement brings a smile to the user's face and spirit, making them feel better, more confident, less alone, and equal to their current tasks where just a moment before they felt overwhelmed and lonely. There is no one in the world who couldn't use a word of cheer and encouragement from time to time along with a smile. The Positive Random Message Generating Device 10 is produced in a variety of spoken languages for international and worldwide utilization. Durably constructed of high quality materials, the Positive Random Message Generating Device 10 will provide users with many years of continued motivational functionality.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A message generating device for providing a user with energy, optimism, courage and positive motivational support, the message generating device comprising:
a base having a top side and a bottom side;
a speaker mounted in the base;
a button depressibly mounted to the top side of the base;
an internal electronic memory storage device mounted within the base for preserving information for retrieval;
wherein upon depressing the button, a positive verbal message is played through the speaker providing a user with energy, optimism, courage and positive motivational support.

2. The message generating device of claim 1 wherein the positive verbal message complements the user reminding them of their positive character and abilities, and set their day back on a positive, optimistic course.

3. The message generating device of claim 1 wherein the positive verbal message is stored in the memory storage device.

4. The message generating device of claim 1 and further comprising:
a plurality of positive verbal messages stored in the memory storage device.

5. The message generating device of claim 4 wherein upon depressing the button, a random positive verbal message is played through the speaker from the plurality of positive verbal messages stored in the memory storage device.

6. The message generating device of claim 5 wherein a different positive verbal message is accessed with each press of the button.

7. The message generating device of claim 6 wherein the positive verbal message is never replayed sequentially.

8. The message generating device of claim 1 and further comprising:
a logo graphically embellished on the button.

9. The message generating device of claim 1 wherein the top side of the base is substantially dome-shaped and the bottom side of the base is substantially flat.

10. The message generating device of claim 9 and further comprising:
a plurality of nonslip rubber pads mounted on the bottom side of the base.

11. The message generating device of claim 1 and further comprising:
a snap locking battery compartment formed in the base.

12. The message generating device of claim 1 wherein the positive verbal message is played in a voice selected from a masculine voice and a feminine voice.

13. The message generating device of claim 1 wherein the positive verbal message is selected from the message consisting of You're the Best, You're Number One, I Like You, You're Marvelous, I'm Your Friend, I'm on Your Side, You're Fantastic, I'm Standing with You, You're a Star, You're a Winner, You're the Greatest, I'm your Buddy, I'm your Pal, I'm Sticking by You, You're So Talented, You're a Pro, You're Spectacular, You Can Do It, and I Stand by You.

14. The message generating device of claim 1 and further comprising:
customized positive verbal messages stored in the memory storage device, the customized positive verbal messages specifically focusing on a user's desired personal attributes and goals.

15. The message generating device of claim 1 wherein the positive verbal message is played in a variety of spoken languages.

16. A method for providing a user with energy, optimism, courage, and positive motivational support, the method comprising:
providing a base having a substantially dome-shaped top side and a substantially flat bottom side;
mounting a speaker in the base;
mounting a depressable button to the top side of the base;
mounting an internal electronic memory storage device within the base for preserving information for retrieval;
depressing the button;
playing a positive verbal message through the speaker; and
providing a user with energy, optimism, courage and positive motivational support.

17. A message generating device for providing a user with energy, optimism, courage, and positive motivational support, the message generating device comprising:
a base having a top side and a bottom side;
a speaker mounted in the base;
a button depressibly mounted to the top side of the base;
an internal electronic memory storage device mounted within the base for storing at least one positive verbal message;
wherein upon depressing the button, the at least one positive verbal message is played through the speaker providing a user with energy, optimism, courage and positive motivational support; and
wherein the positive verbal message complements the user reminding them of their positive character and abilities, and set their day back on a positive, optimistic course.

18. The message generating device of claim 17 and further comprising:
a plurality of positive verbal messages stored in the memory storage device.

19. The message generating device of claim 18 wherein upon depressing the button, a random positive verbal message is played through the speaker from the plurality of positive verbal messages stored in the memory storage device, a different, random positive verbal message is accessed with each press of the button, the positive verbal message is never replayed sequentially.

20. The message generating device of claim 18 wherein the plurality of positive verbal messages are pre-recorded positive verbal messages and/or customized messages, both types of messages specifically focusing on a user's desired personal attributes and goals.
